(19) United States
(12) Patent Application Publication
(10) Pub. No.: US 2026/0209605 A1
(43) Pub. Date: Jul. 23, 2026

(54) RENEWABLE METHANE FOR CO2-STEAM REFORMING SYNGAS MANUFACTURE

(71) Applicant: Aether Fuels Pte. Ltd., Singapore (SG)

(72) Inventors: Conor F. Madigan, Chicago, IL (US); Claudio Bertelli, Chicago, IL (US); Sanjiv Dabee, Aliso Viejo, CA (US)

(73) Assignee: Aether Fuels Pte. Ltd., Singapore (SG)

(21) Appl. No.: 19/446,226

(22) Filed: Jan. 12, 2026

Related U.S. Application Data
(60) Provisional application No. 63/746,423, filed on Jan. 17, 2025.

(51) Int. Cl. C10G 2/00; C01B 3/38

(52) U.S. Cl. CPC C10G 2/32; C01B 2203/0233; C01B 2203/0238; C01B 2203/062; C01B 2203/1241

(57) ABSTRACT

Method and apparatus for manufacturing chemical products using renewable methane sources are described. In one aspect, methods described herein include obtaining methane from a distribution system; obtaining a biogenic CO₂ material; and converting the methane and the biogenic CO₂ material into a liquid hydrocarbon product, wherein the methane is selected to provide a greenhouse gas life cycle assessment (GHG-LCA) of equivalent CO₂ emissions for the liquid hydrocarbon product, based on combusting the liquid hydrocarbon product as a fuel as the end use, that is 50% or less of the GHG-LCA of an equivalent fossil-derived fuel.

### CROSS-REFERENCE TO RELATED APPLICATIONS

This application for patent claims priority benefit of U.S. Provisional Patent Application Ser. No. 63/746,423, filed Jan. 17, 2025, which is entirely incorporated herein by reference.

### BACKGROUND

Biogas is a promising feedstock for the production of sustainable chemical products, because biogas is a source of biogenic methane (CH₄) and carbon dioxide (CO₂) that could be used to make syngas, which can in turn be used for chemical products manufacture. Biogas, however, is frequently not available in large quantities at single locations, making the use of such materials in economically scaled facilities challenging. In addition, biogas production facilities are frequently located in places that do not have readily available renewable power, and/or do not have suitable infrastructure for efficient distribution of chemical products, further challenging the economics of biogas conversion. Methods and apparatus are needed to make use of biogas for sustainable syngas production and chemical product production more feasible, for example, by efficiently allowing for the aggregation of large amounts of biogenic CH₄ and CO₂ in one place and/or at locations distant from the locations where biogas is produced.

### SUMMARY

Embodiments described herein provide methods that include obtaining methane from a distribution system; obtaining a biogenic CO₂ material; and converting the methane and the biogenic CO₂ material into a liquid hydrocarbon product, wherein the methane is selected to provide a greenhouse gas life cycle assessment (GHG-LCA) of equivalent CO₂ emissions for the liquid hydrocarbon product, based on combustion of the liquid hydrocarbon product as a fuel as the end use, that is 50% or less of the GHG-LCA of equivalent CO₂ emissions for equivalent fossil-derived fuel.

Other embodiments described herein provide methods that include supplying, to a hydrocarbon manufacturing facility, through a distribution system, methane that, when reacted with biogenic CO₂ forms a liquid hydrocarbon product that has a greenhouse gas life cycle assessment (GHG-LCA) of equivalent CO₂ emissions, based on combustion of the liquid hydrocarbon product as a fuel as the end use, that is 50% or less of the GHG-LCA of of equivalent CO₂ emissions for equivalent fossil-derived fuel.

Other embodiments described herein provide methods that include obtaining, from a distribution system at a first location, a first volume of methane having a mass that is the same as, or less than, a corresponding second volume of renewably sourced methane input into the distribution system at a second location; obtaining a volume of renewably sourced CO₂; converting the first volume of methane and the volume of renewably sourced CO₂ into a liquid hydrocarbon product, wherein the second volume is selected to provide a greenhouse gas life cycle assessment (GHG-LCA) of equivalent CO₂ emissions for the liquid hydrocarbon product, based on combustion of the liquid hydrocarbon product as a fuel as the end use, that is 50% or less of the GHG-LCA of equivalent CO₂ emissions for an equivalent fossil-derived fuel.

Other embodiments described herein provide methods that include obtaining, from a distribution system at a first location, a first volume of methane having a first mass; causing to be supplied to the distribution system, at a second location different from the first location, a second volume of renewably sourced methane having a second mass equal to or greater than the first mass; combining the first volume with a volume of renewably sourced CO₂ from a biogas facility to form a feed stream; and converting the first volume of methane and the volume of renewably sourced CO₂ of the feed stream into a liquid hydrocarbon product, wherein the second volume is selected to provide a greenhouse gas life cycle assessment (GHG-LCA) of equivalent CO₂ emissions for the liquid hydrocarbon product, based on combustion of the liquid hydrocarbon product as a fuel as the end use, that is 50% or less of the GHG-LCA of an equivalent fossil-derived fuel.

### BRIEF DESCRIPTION OF THE DRAWINGS

FIG. 1 is a process diagram illustrating a process according to one embodiment.

FIG. 2 is a process diagram illustrating a process according to another embodiment.

### DETAILED DESCRIPTION

Methods and apparatus are described herein for producing syngas using a CO₂-steam reforming reactor, wherein at least a portion of the feed for the reactor is sourced either directly or indirectly from renewable sources. The CO₂-steam reforming process comprises contacting mixtures of methane, carbon dioxide, and steam with a suitable catalyst in a CO₂-steam reforming reactor to produce syngas (a mixture of carbon monoxide, CO, and hydrogen gas, H₂) via steam reforming, the conversion of CH₄ and stream into CO and H₂, and dry reforming, the conversion of CH₄ and CO₂ into CO and H₂. It is further noted that a CO₂-steam reforming process will also include a third reaction, the Water Gas Shift-Reverse Water Gas Shift “(WGS-RWGS”) equilibrium, with the relative rate of such “WGS-RWGS” reaction depending the process conditions and relevant activity of the catalyst. A CO₂-steam reforming reactor is part of a CO₂-steam reforming process. In some cases, the CO₂-steam reforming process can be a “triconversion” process reflecting the three reactions described above—steam reforming, dry reforming, and water gas shift, and a CO₂-steam reforming reactor can be a “triconversion” reactor. Herein, reference to CO₂-steam reforming includes the “triconversion” case where the WGS-RWGS reaction is active. The syngas produced by a CO₂-steam reforming reactor, from an appropriate feed stream, has an attractive ratio of H₂ to CO, usually between about 1.5 and 2.5, for example about 2.1, for chemical product manufacture using Fischer-Tropsch methods. This ratio can be tuned by adjusting the input feed composition (e.g. the steam composition relative to the other components, or alternatively, the CO₂ or CH₄ composition relative to the other components) and by adjusting the temperature and pressure (which shift the thermodynamic equilibrium of the various reactions).

The CO₂-steam reforming reactor comprises one or more elongated pressure vessels, such as drums or tubes, that each contain a bed of catalyst, in combination with a heat delivery system that delivers heat into each of the catalyst beds. The heat delivery system provides the necessary heat to drive the CO₂-steam reforming reaction, which is in general endothermic, and any additional heat needed to ensure the gases are at the desired process temperature.

The catalyst bed for CO₂-steam reforming may comprise a single heterogeneous catalyst, e.g. at least one noble metal on a solid support comprising at least one metal oxide, or multiple catalysts, e.g. a first catalyst comprising at least one noble metal on solid support comprising at least one metal oxide and a second catalyst. The catalyst bed has stable activity for steam methane reforming according to equation (1)

CH₄+H₂O═CO+3H₂ (1),

and dry reforming according to equation (2)

CH₄+CO₂═2CO+2H₂ (2).

Here “stable activity” refers to activity having sufficient stability to support operation for at least 500 hours, whether continuously or discontinuously, without undergoing regeneration or replacement.

Conventionally catalysts that have good activity for steam methane reforming do not have good stability under dry reforming conditions, and thus conventionally the feed and process conditions are selected to suppress dry reforming (e.g. by avoiding CO₂ in the feed and/or by utilizing high amounts of steam so that the steam reforming reaction dominates) but such methods may form syngas that is suboptimal for downstream chemical product manufacture, since such syngas would have a ratio of H₂ to CO that is typically above 2.5, where the preferred ratio for chemical product manufacture is between 1.5 and 2.5. Such methods can also be suboptimal where it is desired to use CO₂ as an input and convert it into syngas.

In addition to methane, CO₂, and steam, one can also provide H₂ as an input to the CO₂-steam reforming reactor. As noted above, the WGS-RWGS reaction according to equation (3)

CO+H₂O═CO₂+H₂ (3),

can be active based on the process conditions and catalyst activity for WGS-RWGS. When using a catalyst having good WGS-RWGS activity, one can introduce H₂ as an input to shift the thermodynamic equilibrium of the reaction. In one embodiment of such a process using a CO₂-steam reforming reactor, it is even possible to supply only CO₂ and H₂ as input, in which case the reactor operates primarily as a reverse water gas shift reactor to convert CO₂ into CO.

CO₂-steam reforming catalyst formulations may comprise one or more noble metals on a metal oxide support. The one or more noble metals may be selected from the group consisting of platinum (Pt), rhodium (Rh), ruthenium (Ru), palladium (Pd), silver (Ag), osmium (Os), iridium (Ir), and gold (Au), or preferably from the group consisting of platinum (Pt), rhodium (Rh), ruthenium (Ru), palladium (Pd), and iridium (Ir). The one or more noble metals may be present in an amount equal to 0.01 to 10 wt-%, for example in an amount equal to 0.1 to 5 wt-%. The metal oxide support is porous, and may comprise one or more metal oxides. The one or more metal oxides may be selected from the group consisting of cerium oxide, aluminum oxide, silicon oxide, titanium oxide, zirconium oxide, magnesium oxide, and strontium oxide, for example from the group consisting of cerium oxide, aluminum oxide, and silicon oxide. In certain embodiments, the CO₂-steam reforming catalyst comprises at least one noble metal selected from the group consisting of platinum (Pt), rhodium (Rh), ruthenium (Ru), palladium (Pd), and iridium (Ir) in an amount equal to 0.01 to 10 wt-%, based on the weight of the CO₂-steam reforming catalyst highly dispersed on a solid support comprising ceria and at least one other metal oxide other than ceria, wherein the ceria is present in an amount of between 1 to 80 wt-% of the solid support, for example between 5 to 50 wt-% of the solid support.

When feeding a natural gas stream instead of a pure methane stream, the feed may contain small amounts of hydrocarbons having two or more carbon atoms (referred herein at “C2+ hydrocarbons”.) Prior to feeding such natural gas stream to the CO₂-steam reforming reactor, one can optionally feed the stream to a pre-reformer to convert the C2+ hydrocarbons into methane and/or syngas. Alternatively, the CO₂-steam reforming reactor can be configured to directly convert C2+ hydrocarbons in addition to methane and/or syngas, via either direct steam and dry conversion reactions with the C2+hydrocarbon or via pre-reforming into methane and/or syngas followed by the normal steam and dry methane reforming reactions. When incorporating CO₂ with hydrocarbons in a CO₂-steam reforming reactor, for example to boost syngas yield and reduce excess H₂ generation, CO₂ may be present at levels above what would otherwise be present in a typical methane or natural gas stream. For example, in typical pipeline natural gas there is a certain amount of CO₂ present. In North America, the typical pipeline specification for CO₂ in natural gas is 0.1 to 1.0 mol-%. In some CO₂-steam reforming processes, CO₂ may be present in the reactor feed in an amount equal to at least about 2 mol-%, at least about 5 mol-%, or at least about 10 mol-%.

The heat delivery system of the CO₂-steam reforming reactor may utilize conventional combustion-based heating, referred frequently to “firing” so that such a reactor is sometimes called a “fired reactor.” In such cases, a fuel gas is supplied to the heating system and is combusted to produce heat, which is applied to the walls of the pressure vessel and transferred through the walls into the catalyst bed of the reactor. Alternatively, the heat delivery system of the CO₂-steam reforming reactor may utilize electrical-based heating, wherein electric heating elements that convert electrical current and voltage into heat, such as resistive heating elements or inductive heating elements, are configured to generate heat that is then delivered into the catalyst bed. The heat delivery system may have multiple sections, wherein different heat fluxes can be delivered to the catalyst bed in each section to control the temperature in the catalyst bed in each section more precisely. As noted above, the CO₂-steam reforming reactor and process can be controlled, and provided with a blend of feedstocks, to yield syngas having a favorable molar ratio of H₂ to CO for chemical product manufacture, which is typically a ratio of about 1.5 to 2.5, for example about 2.1.

In general, when preparing feeds for a CO₂-steam reforming process, mixtures of CO₂ and hydrocarbon are typically used. The amount of steam and CO₂ is selected to produce syngas with a desired ratio of H₂:CO while yielding a minimum of excess H₂. The amount of CO₂ that meets such criteria depends on the composition of the hydrocarbon and the total conversion of the components. In some special cases, it is easy to determine the optimal quantity of CO₂ to use. For example, if the reactor feed consists of CO₂ and CH₄ (and the appropriate amount of steam), and assuming full conversion, equations (1) and (2) provide that a feed with CH₄:CO₂ molar ratio of 3 yields syngas with H₂:CO molar ratio of 2, with no excess H₂ produced.

In some cases, the carbon containing portion of the feed to a CO₂-steam reforming process may include CO₂, CH₄, and a minority portion of gaseous alkane hydrocarbons, such as ethane, propane, butane, and small amounts of higher carbon number components. This is, for example, representative of a case where the carbon containing portion of the feed has the composition of the carbon containing components of pipeline natural gas. With ethane (C₂H₆), dry reforming and steam reforming net reactions are given by equations (4) and (5), respectively,

2CO₂+C₂H₆→4CO+3H₂ (4)

2H₂O+C₂H₆→2CO+5H₂ (5),

and in general, for an alkane hydrocarbon with n carbon atoms (designated here “AHn”), the relevant net reactions are given by equations (6) and (7), respectively,

(n)CO₂+AHn→2(n)CO+(n+1)H₂ (6)

(n)H₂O+AHn→(n)CO+(2n+1)H₂ (7)

Assuming full conversion, then, for each AHn component, the ratio of the steam reaction to the dry reaction required to produce H₂:CO of 2 is equal to 3n-1. It is evident from this equation that as n increases, the steam reaction increasingly dominates, and less CO₂ is needed to ensure no excess H₂ is produced (noting that CO₂ only participates in the dry reaction). A pure CH₄ stream can thus utilize the largest amount of CO₂ to produce a target H₂:CO ratio syngas without excess H₂, and such amount of CO₂ decreases as the amount of AHn components with n>1 increases. More generally for a given AHn the ratio of the steam reaction to the dry reaction required to produce syngas with a H₂:CO ratio of X (assuming full conversion), which we herein define as alpha (X), is equal to [X(2n)−(n+1)]/[(2n+1)−Xn]. In this context, “net” reaction refers equivalently to the result of single step reforming, or if pre-reforming is used, the result of pre-reforming followed by reforming.

In most cases, syngas having H₂:CO molar ratio between about 1.5 and about 2.5 is desired for use in making chemical products. The dry reforming reaction of AHn yields syngas with H₂:CO ratios that are equal to or less than 1, for example, if n=1 (i.e. dry reforming of methane) the H₂:CO ratio resulting from the reaction is 1, whereas for large n (i.e. dry reforming of long carbon chain alkanes) n is about 0.5. Similarly, the steam reforming reaction of AHn yields syngas with an H₂:CO molar ratio of 3, for n=1, and about 2 for large n alkanes. Thus, dry reforming (and by extension CO₂) can only be usefully incorporated into the reforming process when the H₂:CO ratio produced by steam reforming alone is higher than the target ratio, such that introducing dry reforming (and thus CO₂ conversion) can be used to bring down the H₂:CO ratio to the desired level without requiring the removal of excess H₂. One can also consider the impact of having hydrocarbons present in the feed other than alkanes. Chemically, alkanes contain the maximum amount of H atoms for a given number of carbon atoms, and for this reason they yield the highest molar ratio of H₂:CO when steam reformed into syngas. Thus, inclusion of any non-alkane hydrocarbons, such as alkenes or aromatics, will cause the H₂:CO molar ratio produced from steam reforming alone to be reduced, and in turn this will reduce the amount of CO₂ that can be usefully incorporated by dry reforming, relative to the amount for a hydrocarbon stream of just methane.

In cases where CO₂ is added to a hydrocarbon stream to prepare a feed for conversion, using CO₂-steam reforming, into syngas having an H₂:CO molar ratio of between about 1.5 and about 2.5, the hydrocarbon portion of the feed may contain methane in an amount equal to at least about 60 mol-% of the hydrocarbon containing portion of the feed, such as at least about 80 mol-% of the hydrocarbon containing portion of the feed, for example at least about 90 mol-% of the hydrocarbon containing portion of the feed. The hydrocarbon portion of such feed may contain alkanes having more than 1 carbon atom in an amount equal to less than about 40 mol-% of the hydrocarbon containing portion of the feed, such as less than about 20 mol-% of the hydrocarbon containing portion of the feed, for example less than about 10 mol-% of the hydrocarbon containing portion of the feed. Similarly, the hydrocarbon portion of the feed may contain non-alkane components in an amount equal to less than about 10 mol-% of the hydrocarbon containing portion of the feed, such as less than about 5 mol-% of the hydrocarbon containing portion of the feed, for example less than about 2 mol-% of the hydrocarbon containing portion of the feed.

The above description of the amount of CO₂ that can be usefully added to the feed for a CO₂-steam reforming process assumes full conversion of the components, but in practice full conversion is usually not observed due to the limitations imposed by thermodynamic equilibrium. However, it is possible to get higher conversion rates than the conversion predicted by such equilibrium in a single-pass configuration by recycling the unconverted CO₂ and/or hydrocarbon components. Such recycling can be implemented immediately after the CO₂-steam reforming process by separating the desired unconverted components from an effluent of a CO₂-steam reforming reactor, or from any unit of the CO₂-steam reforming process that is prior to routing syngas to a downstream process, and routing them back to the CO₂-steam reforming process, or such recycling can be performed following one or more downstream processes. For example, a plant for chemical product manufacturing may utilize downstream processes that produce such chemical products, for example, Fischer-Tropsch (FT) synthesis to produce liquid hydrocarbons or methanol synthesis to produce methanol. In cases where FT synthesis is used, such FT synthesis step may produce certain amounts of by-product gases (sometimes alternatively called “tail gases” or “off gases”), and such gases may contain CO, H₂, CH₄, and CO₂, which can be internally recycled to the upstream CO₂-steam reforming process to produce additional syngas with a suitable H₂:CO ratio. In cases where internal recycling, as described herein, is utilized, the portion of the feed to the CO₂-steam reforming process that is not derived from such internally recycled feeds is herein referred to as the “fresh feed” and the combination of the fresh feed and the internally recycled feeds is referred to as the “total feed”.

In many cases, then, such recycling can be advantageous. In general, it is possible to achieve at least about 60% conversion of the CO₂ and hydrocarbon components using such recycling methods with a suitably-configured plant, or at least about 75%, 85% or even 90% of the CO₂, hydrocarbons, or both. In the case of incomplete single-pass conversion, and particularly incomplete conversion leading to different conversion rates of CO₂ and the hydrocarbon, the optimal amount of CO₂ in the feed to produce syngas having a target H₂:CO ratio will depend on the component conversion rates. In consideration of such factors, when adding CO₂ to a hydrocarbon steam to create a feed stream for feeding a CO₂-steam reforming process to make syngas having an H₂:CO ratio of between about 1.5 and about 2.5, a molar ratio of CO₂ molecules to carbon atoms in the hydrocarbon portion of either the fresh feed or the total feed (or equivalently, a ratio of carbon atoms in CO₂ to carbon atoms in the hydrocarbon portion of the feed) may be between about 1:10 to about 1:1, for example between about 1:6 to about 1:2.

Methods described herein leverage methane (CH₄) renewably produced by one or more facilities, such as biogas facilities, and CO₂, which may be renewably produced by a biogas facility or another facility, to provide feedstocks for a CO₂-steam reforming reactor to make syngas suitable for chemical product manufacture, e.g. using a Fischer-Tropsch process to make liquid hydrocarbons. Biogas facilities typically produce methane and CO₂ in small quantities. Existing technology is available to separate the CO₂ from the methane, and then further purify the resulting methane stream, to make renewably sourced methane, sometimes also called biomethane or renewable natural gas. Such methane can be provided to a distribution system at many different locations and then a stream comprising methane can be withdrawn from the distribution system to feed a CO₂-steam reforming process to make syngas that can be provided to a conversion process to make renewably sourced chemical products. Because a volume of renewable natural gas or methane is input into the distribution system, the stream withdrawn from the distribution system, and therefore any products made from such stream, comprise the environmental attributes of the material input into the distribution system. For example, such products can have a greenhouse gas life cycle assessment of equivalent CO₂ emissions (GHG-LCA) that comprises the GHG-LCA of the material input into the distribution system.

Pipeline natural gas commonly includes components other than methane, such as propane and butane, whereas renewably sourced methane comprises just methane. When injecting such renewably source methane into a distribution system, this methane may be converted into an equivalent amount of natural gas on an energy basis or on a mass basis. Energy bases used for such comparisons include the lower heating value (LHV) or higher heating value (HHV) of the renewably sourced methane in units of millions of British thermal units (“mmBtu”), mega joules (“MJ”) or megawatt hours (“MWh”). Energy is typically used in commercial natural gas settings to quantify natural gas, and energy is typically utilized when determining the equivalent amount of renewably sourced methane injected into a natural gas pipeline. However, this distinction is often not critical for the applications described herein as energy and mass bases often differ very little; this is because the energy density for a given mass of pure methane and the mixture of hydrocarbons present in natural gas (which is primarily methane and small amounts of ethane, propane, and butane) are very similar.

A large CO₂-steam reforming reactor can efficiently convert a large amount of methane, and optionally CO₂, but biogas streams are typically available in smaller quantities. Methods described herein utilize methane from one or more first facilities, which may include biogas facilities, injected into a distribution system, such as a natural gas pipeline system, to provide feedstocks to the CO₂-steam reforming reactor. Such first facilities need not be near the reactor. Injecting suitable renewable natural gas from biogas facilities, for example, wherever they are located, allows a single CO₂-steam reforming reactor having suitable commercial scale to utilize renewable natural gas regardless of the size and location of the individual streams of biogas. Such methods also allow the CO₂-steam reforming reactor to be located in an area with a large amount of CO₂ available from a single nearby source and with useful renewable power resources and other infrastructure.

In one method, a first volume of methane is withdrawn from a distribution system such as a natural gas pipeline and routed to a CO₂-steam reforming facility. A second volume of renewably sourced methane can be identified, for example using attributes described herein for designating biogenic origin, and associated with the first volume of methane in such a way that chemical products, such as liquid fuels, for example methane or liquid hydrocarbons, made from the first volume of methane are biogenic, sustainable, and/or renewable chemical products. The environmental attributes of the first volume thus comprise the environmental attributes of the second volume. Such second volume comprising renewably sourced methane can be obtained from a biogas facility. The second volume can be separated from the output of the biogas facility to yield a highly pure methane-containing stream that meets commercial natural gas specifications for injection into, and transport through, a distribution system such as a natural gas pipeline. Such suitably prepared methane-containing stream is alternatively referred to as renewable natural gas. The second volume is provided to a distribution system, which may be a distribution system for natural gas or other methane distribution system, at a location near the biogas facility. A single party can withdraw the first volume from the distribution system and provide the second volume to the distribution system, or cause the second volume to be provided to the distribution system.

At the location of the CO₂-steam reforming reactor, which is optionally not near the biogas facility, the first volume comprising methane, such as a volume of natural gas, is withdrawn from the distribution system. The first volume can have the same energy content as the second volume, or a different energy content. In general, where the first volume has the same or less mass or energy content than the second volume, and where the first volume is allocated, proportional to the ratio of the mass or energy contents, substantially all of, the renewable composition and sourcing attributes of the second volume, the first volume can be said to comprise renewably sourced methane (or renewable natural gas) and the CO₂-steam reforming reactor can be said to produce syngas from such renewable methane (or renewable natural gas). Thus, an operator of a CO₂-steam reforming facility can identify a corresponding first volume of methane and/or natural gas and one or more second volumes of methane and/or natural gas, ensure the one or more second volumes, comprising renewably sourced methane, is input into the distribution system, and be afforded by such action the benefit of making products using the CO₂-steam reforming facility that are biogenic, sustainable, and/or renewable. In other embodiments, a majority or at least a portion of the renewable composition and sourcing attributes of the second volume are allocated to the first volume, such that the first volume comprises at least a portion of renewable methane (or renewable natural gas). In many such cases, syngas made using such raw materials can be referred to as renewable syngas.

Chemical products made from such syngas have reduced carbon dioxide equivalent (CO2e) emissions when calculated using a suitable lifecycle analysis of greenhouse gas (GHG-LCA) emission methodology, if the renewable composition and sourcing attributes of the renewably sourced methane added to the distribution system are attributed to the natural gas withdrawn from the distribution system. For example, chemical products produced using methods described herein can contribute less than about 50%, or less than about 65%, or less than about 70% of the CO2e emissions of an equivalent amount of an equivalent chemical product produced from feedstocks having conventional fossil environmental attributes using a conventional method. In such cases, the renewably sourced methane is typically added to the distribution system at a time that is before, or concurrent with, the time the natural gas is withdrawn from the distribution system. In some cases, the renewably sourced methane can be added to the distribution system at a time that is within a prescribed duration after the natural gas is withdrawn from the distribution system. Thus, addition of the renewably sourced methane to the distribution system can begin, and can be completed, before withdrawal of the natural gas from the distribution system. Alternately, addition of the renewably sourced methane to the distribution system can begin before withdrawal of the natural gas from the distribution system, and addition of the renewably sourced methane to the distribution system can end before or after withdrawal of the natural gas from the distribution system ends. Alternately, addition of the renewably sourced methane to the distribution system can begin after withdrawal of the natural gas from the distribution system begins and before withdrawal of the natural gas from the distribution system ends, and can end before or after withdrawal of the natural gas from the distribution system end. Alternately, addition of the renewably sourced methane to the distribution system can begin and/or end within a prescribed duration after withdrawal of the natural gas from the distribution system is completed and ends.

As one example, the chemical product can be a sustainable aviation fuel (SAF), and the CO2e emissions can be evaluated using the Argonne National Laboratory GREET LCA-GHG model (also known as the “R&D GREET” model) using the “mass balance” or “energy balance” principal, under which renewable methane, for example in a stream comprising or consisting essentially of renewable methane, injected into a physical system containing mixed renewably sourced and non-renewably sourced (i.e. fossil derived) molecules, can be deemed removed at another point of the same physical system provided the appropriate system of attributes is applied to ensure that the environmental burden of the injected and removed material is the same or beneficially comparable. Where the same type of molecule is injected and removed, mass balancing or energy balancing can be used.

In the special case of renewably sourced methane injection and natural gas removal, typically energy balancing is used, as the functional value of the injected and removed material is usually the energy content rather than the mass (which differs slightly from the energy due to the small amount of chemical components in pipeline natural gas other than methane). However, as noted earlier, the difference between energy and mass balancing in such cases is small as the chemical components in the pipeline other than methane make up a small portion of the total composition, e.g. less than about 10% or less than about 5%, or less than about 2% on a volume basis. Such a balancing principle in LCA-GHG calculations allows a unit of material having the same functional value in that physical system as another, renewably sourced, unit of material, to be removed from another part of that physical system, and allows the CO2e LCA-GHG emissions attributes and/or the biogenic origin of the renewably sourced unit of material to be attributed to the removed unit of material. This eliminates the need to track individual renewably sourced molecules through the physical system, and enables efficient sharing of existing fossil infrastructure like existing natural gas pipelines. The CO2e emissions attributes and/or the biogenic origin attributes of the injected renewably sourced unit of material are effectively “attached” to the removed unit of material. Thus, if the renewable attributes of renewably sourced methane injected into a distribution system are attributed to methane or natural gas withdrawn from that system, by deeming the withdrawn material to be equivalent (using the relevant balancing system) to the previously injected renewably sourced molecules for emissions evaluation purposes, then the biogenic origin and/or CO2e emissions, calculated using a suitable LCA-GHG methodology, of a subsequently produced chemical product will be accordingly based on the renewable sourcing and composition characteristics of the renewably sourced methane. Alternatively, those renewable attributes could instead be attributed to the syngas or the chemical product, rather than to the withdrawn methane, to ascertain the biogenic origin or LCA-GHG CO2e emissions of the syngas or chemical product.

Many recognized systems can be used to define conditions under which renewable attributes of a mass of methane injected into a methane distribution system can be attributed to a stream used for chemical products manufacture. EU Implementing Regulation 2022/996, issued Jun. 14, 2022, is an example. Where a first stream, containing a first volume of methane or natural gas, withdrawn from a distribution system meets the definitions and criteria in the EU standard above, the renewable attributes of a second volume of renewable methane injected into the distribution system can be transferred from and attached to the first volume in the first stream. Among the elements of the EU standard that can be used is a “proof of sustainability” that can be associated with a second volume of methane injected into a distribution system, such that a first volume withdrawn from the same distribution system, either as pure methane or as a stream containing methane, can be assigned the renewable environmental attributes of the second volume.

Other systems that can be used include the California (CA) LCFS, U.S. RFS systems, and U.S. Department of Treasury guidelines for the 45V production tax credit. Among the elements of these systems is a “book and claim chain of custody” system allowing physical molecules and the environmental attributes of those molecules to be traded separately. These systems specify that the first volume of methane or natural gas must be withdrawn from the same physical system into which the second volume of methane is injected for the first volume to be assigned the renewable attributes of the second volume. The EU RED system for comparability of environmental attributes is documented at https://eur-lex.europa.eu/legal-content/EN/TXT/?uri=CELEX % 3A32023L2413&qid=1699364355105. That system also includes procedures for computation of LCA-GHG generally for manufacturing and transportation systems. The CA LCFS system can be accessed at https://ww2.arb.ca.gov/our-work/programs/low-carbon-fuel-standard/lcfs-regulation. The U.S. Renewable Fuel Standard (RFS) system can be accessed at https://www.epa.gov/renewable-fuel-standard/statutes-and-regulations-under-renewable-fuel-standard. Another system that can be used is the CORSIA system, available at https://www.icao.int/CORSIA/implementation-elements. The CORSIA system also includes procedures for computation of LCA-GHG generally for manufacturing and transportation systems.

GHG-LCA calculations of equivalent CO₂ (CO2e) emissions are generally performed following specified methodologies. In some instances, such specified methodologies have reference calculators which may be used to calculate the equivalent CO2e emissions on a GHG-LCA basis. Where a reference calculator exists, the CO2e emissions on a GHG-LCA basis for such methodology may be calculated using such reference calculator. Alternatively, the CO2e emissions on a GHG-LCA basis may be calculated using any tool or process that is consistent with the specified methodology. The Argonne National Laboratory GREET model (also referred to as R&D GREET) is one of the methodologies that offers a reference calculator. The R&D GREET methodology and reference calculator for any available year (e.g. 2023, 2024, or 2025, e.g. available at https://greet.anl.gov/net) can be used. Additionally, the version of the GREET methodology and reference calculator developed specifically for California (which is used in connection with the CA LCFS program), e.g. CA-GREET3.0 and CA-GREET4.0 e.g., available at https://ww2.arb.ca.gov/resources/documents/lcfs-life-cycle-analysis-models-and-documentation) can be used. A version of the GREET methodology and reference calculator for the 45V production tax credit in the U.S. (e.g. available at https://www.energy.gov/cmei/45vh2-greet-archive) can be used. Alternatively, any of the GHG-LCA methodologies specified by the U.S. RFS system (e.g. available at https://www.epa.gov/renewable-fuel-standard/lifecycle-analysis-greenhouse-gas-emissions-under-renewable-fuel-standard), CORSIA available (e.g. at https://www.icao.int/CORSIA/implementation-elements) or the European Union (EU) Renewable Energy Directive (RED) (e.g. available at https://energy.ec.europa.eu/topics/renewable-energy/renewable-energy-directive-targets-and-rules/renewable-energy-directive_en) may be used.

The above GHG-LCA methodologies can be used to calculate the GHG-LCA equivalent CO₂ (CO2e) emissions for a liquid fuel product, based on combustion as a fuel as the end use. Most commonly for fuels, such CO2e emissions are calculated using units of mass of CO2e emitted per unit energy of fuel, where such unit energy of fuel is most commonly based on either the lower heating value (LHV) or the higher heating value (HHV) of the fuel. While there are differences between the exact values calculated under each methodology, the following are typical GHG-LCA CO2e emissions reference values for fossil derived fuels where combustion as a fuel is the end use: hydrogen=75 CO2e per MJ of LHV energy in the hydrogen fuel, methanol=93 grams CO2e (gCO2e) per MJ of LHV energy in the methanol fuel, ammonia=90 gCO2e per MJ of LHV energy in the ammonia fuel, jet fuel=95 gCO2e per MJ of LHV energy in the jet fuel, diesel fuel=89 gCO2e per MJ of LHV energy in the diesel fuel, and gasoline=98 gCO2e per MJ of LHV energy in the gasoline fuel. Various embodiments of the inventions described herein can be used to produce liquid hydrocarbon products having GHG-LCA equivalent CO2e emissions, where combustion of the liquid hydrocarbon product as a fuel is the end use, that are 25% less, 50% less, 65% less, 75% less, and 90% less than a reference value (calculated under a suitable GHG-LCA methodology) for a fossil derived equivalent fuel. Herein “fossil derived equivalent fuel” means: fossil derived diesel fuel, for comparison with a diesel fuel (or diesel fuel blend stock) product; fossil derived gasoline, for comparison with a gasoline (or gasoline blend stock, including naphtha) product; fossil derived jet fuel, for comparison with a jet fuel (or jet fuel blend stock) product; fossil derived methanol, for comparison with a methanol product, etc. Various embodiments of the inventions described herein can be used to produce liquid hydrocarbon products having GHG-LCA equivalent CO2e emissions in units of grams of CO2e emitted per MJ of LHV energy in the liquid hydrocarbon product, where combustion of the liquid hydrocarbon product as a fuel is the end use, that are less than about 75 gCO2e/MJ, 50 gCO2e/MJ, 35 gCO2e/MJ, 25 gCO2e/MJ, and 10 gCO2e/MJ.

Calculations compliant with the above methodologies, and where applicable, their corresponding reference calculators, generally return the carbon intensity of a fuel pathway based on formatted and defined inputs, allowing different production pathways for producing hydrocarbon products to be compared on a standard basis. Where a first volume of methane or natural gas is withdrawn from a distribution system under conditions, specified by relevant standards as described above, that give rise to reliable comparability with a second volume of methane, LCA-GHG calculations can be performed using the systems and calculators above, and using the first volume of methane or natural gas as a designated input to a hydrocarbon manufacturing process and having the renewable attributes of the second volume of renewable methane, such calculations can be used to determine the carbon intensity of any products made using the first volume as if the second volume was used to make the products. In such cases, the GHG-LCA, and/or the carbon intensity, of the first volume comprises the GHG-LCA, and/or the carbon intensity, of the second volume.

In such instances, the carbon intensity of the first volume can comprise the sum of the carbon intensity of the second volume and a “transport carbon intensity” equal to the carbon intensity of any emissions associated with transporting a specified volume, mass, or energy of gas from the point of injection of the second volume to the point of removal of the first volume. Such specified volume, mass, or energy may be respectively the volume, mass, or energy of the first volume, or respectively the volume, mass, or energy of the second volume, depending on the methodology. In some instances, the transport carbon intensity will be calculated using the energy of the first volume and the actual transport distance. In some instances, a methodology will specify a transport carbon intensity based on the energy of the first volume without consideration of the transport distance (e.g. by applying to all cases an average transport distance). In the case that multiple means of transport are utilized (for example, in a distribution system that utilizes a pipeline network followed by tanker ships, trucks, or rail case), separate “transport carbon intensity” values may be applied in series to account for each transport means. The carbon intensity of the second volume, in the case of many renewable natural gas feeds, can be equal to the sum of the carbon intensity of the emissions (if any) associated with producing and collecting the feedstocks used to produce the biogas, producing the biogas itself, removing the CO₂ and any contaminants in the biogas (so that it meets the relevant pipeline spec)—a process referred to typically as “upgrading”—and compressing the resulting renewable natural gas to the relevant pipeline pressure. In some methodologies, emissions that are avoided as a result of collecting and processing the waste into renewable natural gas are counted as negative emissions. In the case of biogas produced from waste feedstocks, the carbon intensity of the waste itself is often assigned a value of zero, and then only those emissions associated with subsequently processing that waste into renewable natural gas are included in the carbon intensity calculation.

In certain embodiments, the first volume can be withdrawn as natural gas, where the majority component is methane. In general, the first volume can be a stream, or a component of a stream, that is withdrawn from the distribution system. In one case, the first volume is a natural gas stream (including not only methane but also C2+components). In that case the energy content of the withdrawn stream may be the same as, or less than, the energy content of the second volume, and the first volume (or withdrawn stream) may be assigned a portion of, and for example a majority of, substantially all, or all the renewable attributes of the second volume. The first volume, in such cases, may be assigned a pro-rata portion of the renewable attributes of the second volume based on the energy content of the first volume and the second volume. In such cases, the first volume can be deemed to consist of renewable natural gas and the CO₂-steam reforming reactor can be said to produce syngas from such renewable natural gas. In such case that all of the renewable attributes of the second volume are attributed to the first volume, and the first volume has the same energy content as the second volume, or lower energy content, the syngas will have the LCA-GHG CO2e emissions as if made using the second volume. Additionally, a third volume of methane (or alternatively natural gas) may be provided to the CO₂-steam reforming reactor from a biogas facility located near the CO₂-steam reforming reactor, to produce additional syngas from such renewable methane (or renewable natural gas). Such methods are, thus, methods of producing renewably sourced syngas and renewably sourced chemical products.

The CO₂-steam reforming reactor can be advantageously located near a point source emitter of CO₂, for example a CO₂ point source emitter emitting CO₂ of biogenic origin, such as a pulp mill or bio-ethanol plant, to provide CO₂ as a co-feedstock for the reactor. The reactor is also capable of consuming CO₂ by-products from industrial processes, such as oil refining, petrochemical synthesis, steel making and power generation. The CO₂-steam reforming reactor is capable of converting methane and CO₂ to make syngas having a favorable ratio of hydrogen gas to carbon monoxide by controlling relative flow rates of CO₂, methane, and steam provided to the reactor, and by controlling temperature and pressure in the reactor. While the reactor can be used in a system to produce syngas with a desired ratio of H₂ to CO between 1.5 and 2.5 with a methane (or natural gas) feed alone, using a feed that includes both methane (or natural gas) and CO₂ can increase the syngas yield per mass of CH₄ input and simplify the overall system complexity.

When converting CH₄ alone using the methods described herein, each mole of CH₄ converted via steam reforming (CH₄+H₂O═3H₂+CO) produces one mole of syngas with H₂ to CO molar ratio of 3. If a lower ratio of H₂ to CO is wanted, one could introduce an H₂ separation unit, such as a membrane separator and/or pressure swing absorber, to remove some of the excess H₂ and potentially use such excess H₂ for another purpose. Alternatively, CO₂ can be added to the CH₄ to convert a portion of the CH₄ using the dry reforming reaction (CH₄+CO₂═2CO+2H₂). In such cases, there are now two reactions operating in parallel to convert CH₄ and by adjusting the amount of steam and CO₂, these two reactions can be balanced to provide syngas yield per mole of CH₄ having a target ratio of H₂ to CO with no by-products. As noted above, by supplying 3 moles of CH₄, 1 mole of CO₂, and 2 moles of H₂O, complete conversion yields 4 moles of syngas with a ratio of H₂ to CO of 2 and no by-products according to equations (1)-(3):

2moles×(CH₄+H₂O=2CO+6H₂);

1mole×(CH₄+CO₂═2CO+2H₂);

result: 4 moles×(CO+2H₂).

In general, where a syngas stream is desired that has molar ratio of H₂ to CO of between 1.5 and 2.5, adding CO₂ to pure methane (where such pure methane is in this context a “CO₂ lean” material in the sense that it has less CO₂ than the amount required to produce the desired H₂ to CO₂ ratio without H₂ removal) in the reaction mixture can increase yield of such a stream and reduce production of byproducts like excess hydrogen. A proportion of CH₄ and CO₂ to provide as a reaction mixture can be determined based on a desired H₂ to CO ratio in the product syngas. In addition, converting CO₂ to syngas can reduce CO₂ emissions. In contrast to pure methane, raw biogas is usually a “CO₂ rich” stream in the sense that it has more than the amount of CO₂ needed to produce syngas having a molar ratio of H₂ to CO that is between 1.5 and 2.5. In such cases, excess CO₂ does not react, and would either be removed prior to feeding or it will pass through the system and be vented/exhausted as a waste off-gas. In the latter case, the excess CO₂ is inert mass that increases the gas mass load on the system, e.g. increasing reactor sizes, heat duties, and compression duties, and so it is in principle preferable to remove the CO₂ prior to syngas conversion, but since CO₂ removal has its own added costs, in some cases it may be economically preferable to let the CO₂ pass through the system. While the exact composition of biogas varies from plant to plant (and over time), typically the molar ratio of CH₄ to CO₂ ratio of a biogas stream is between about 1 and about 2. A feed molar ratio of CH₄ to CO₂ of 3, in contrast, can be converted to syngas, as described above, having a molar ratio of H₂ to CO of 2 with no excess CO₂ or hydrogen as a byproduct. While one can adjust for excess CO₂ by removing that excess CO₂, as noted this can add cost; alternatively, one can add methane as described above and produce more syngas.

In one method, one can feed to a CO₂-steam reforming reactor a first volume comprising methane and a volume of CO₂, both supplied from a first biogas facility that is near the reactor. As described above, the volume of CO₂ in such a stream may be in excess of the optimal amount to maximize syngas yield per mole of methane and minimize the amount of excess CO₂ entering the system. One can also inject into a natural gas pipeline system, or other distribution system or aggregation of methane, from a second biogas facility, a second volume comprising methane that has been purified into a stream that meets commercial natural gas specifications for injection into, and transport through, a natural gas pipeline system. One can also withdraw a third volume comprising methane or natural gas from the natural gas pipeline system and feed the third volume to the CO₂-steam reforming reactor along with the first volume and the volume of CO₂. The third volume can have the same mass or energy content as the second volume, or can be the same amount (e.g. liters, cubic meters, or other volume amount) as the second volume, or different. In general, where the third volume has the same or less energy content as the second volume, and where the third volume is allocated, according to energy content of the first and third volumes, at least a portion of, and preferably a majority or substantially all of, the renewable environmental attributes of the second volume (e.g. under specified “book and claim” or mass/energy balance methods), the third volume can be said to consist of renewably sourced methane or renewable natural gas.

In the case that the third volume comprises natural gas, it may optionally be subjected to a pre-reforming step, by passing the stream through a pre-reforming reactor, to convert C2+ hydrocarbons that may be present into methane. In such cases, the pre-reforming reactor can be part of the CO₂-steam reforming process, such that the CO₂-steam reforming process comprises a pre-reforming process. In cases where the CO₂-steam reforming process comprises a pre-reforming process, any stream, or portion of a stream, to be processed by the CO₂-steam reforming process can be subjected to the pre-reforming process. Alternately, all streams to be processed by the CO₂-steam reforming process can be subjected to the pre-reforming process. The third volume can be selected so that the combination of the first and third volumes with the volume of CO₂ yields a composition that is advantageous for efficient conversion into syngas that has a molar ratio of H₂:CO of 1.5 to 2.5. For example, the third volume can be selected so that the combination of the first and third volumes with the volume of CO₂ results in a composition to efficiently produce syngas having a molar ratio of H₂:CO that is about 2 while also minimizing the production of excess H₂. In the fresh feed to the CO₂-steam reformer in such method, the ratio of carbon in the hydrocarbon portion of such carbon in CO₂ may be between about 2 and about 6, for example, between about 3 and 5.

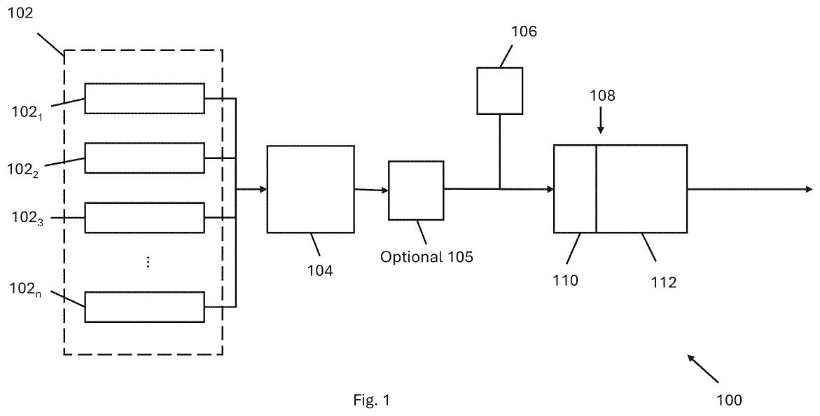

FIG. 1 is a process diagram illustrating a process 100 according to one embodiment. The process 100 has a chemical manufacturing facility 108 that includes a CO₂-steam reforming facility 110 and a chemical production facility 112, which may be, for example, a Fischer-Tropsch (“FT”) facility producing liquid hydrocarbons, a methanol facility producing methanol, or another chemical production facility converting syngas into chemicals. The CO₂-steam reforming facility 110 converts CO₂ and methane into syngas for use in the FT facility 112.

The process 100 has a distribution system 104, which may be a methane or natural gas distribution system, that collects methane or, when the distribution system 104 is a natural gas pipeline network, methane or natural gas, from a plurality of sources 102 and dispenses methane, or, for a natural gas pipeline network, natural gas, to any users that are connected to such distribution system 104. In some instances, the distribution system 104 comprise transport via one or more tanker ships, trucks or rail cars, and/or one or more physical pipeline networks. In such example, such one or more tanker ships, trucks or rail cars receive methane or natural gas directly from the source or from the pipeline network via a physically attached connection that fill the tanks on such tanker trucks or rail cars, and such trucks or rail cars then transports the methane or natural gas to one of: (a) a pipeline network; (b) one or more tanker ships, trucks or rail cars; (c) or the user. In one illustrative example, a distribution system 104 comprises a pipeline network followed by transport via tanker rail cars, for example, in cases where the user does not have a direct physical connection to the pipeline network but has nearby rail lines suitable for transporting such methane or natural gas from the pipeline network to the user. Herein the distribution system 104 may encompass any combination or one or more fixed methane or natural gas transport infrastructure elements (e.g. pipeline networks) and one or more vehicles suitable for transporting tanks of methane or natural gas (e.g. tanker ships, trucks and rail cars). Each source 1021 to 102n provides methane or, when the distribution system 104 is a natural gas pipeline network, methane or natural gas, meeting a grid specification into the distribution system 104. The distribution system 104 can provide methane or, when the distribution system 104 is a natural gas pipeline network, natural gas, to any user. The manufacturing facility 108 is configured to withdraw methane or, when the distribution system 104 is a natural gas pipeline network, natural gas, from the distribution system 104.

The distribution system 104 can balance methane withdrawn from the system 104 with inputs to the distribution system 104 from the sources 102. Or alternatively where the distribution system 104 is a natural gas pipeline network, the distribution system 104 can balance natural gas withdrawn from the distribution system 104 with methane or natural gas inputs from the sources 102. The manufacturing facility 108 can communicate to the distribution system 104 a consumption amount of methane or natural gas withdrawn from the distribution system 104, so the distribution system 104 can balance inputs and outputs.

One or more of the methane or natural gas sources 102 may be a methane source that uses renewable material sources to generate methane. For example, one or more of the sources 102 may be a biogenic methane source that generates methane via the conversion of biogenic wastes like sewage (or waste water in general), manure, farming and agricultural waste, and municipal solid waste into methane, for example, via from the action of anerobic bacterial metabolism. Having a large number of such methane sources can provide methane to supply a manufacturing facility like the facility 108 to produce organic chemicals from renewable sources.

It should be noted that one or more of the methane or natural gas sources 102 may provide methane obtained from subterranean fossil-derived hydrocarbon deposits, and often the vast majority of the methane or natural gas in distribution system 104 may be fossil derived, such that on a molecular basis, more than about 80%, 90%, 95%, or 98% of the methane or natural gas supplied to 108 from 104 is chemically of fossil origin. Where a first volume of methane or natural gas withdrawn from the distribution system 104 and provided to the manufacturing facility 108 has similar or equal energy content to a second volume of methane provided to the distribution system 104 from renewable methane sources among the sources 102, and a suitable balancing methodology, as described above, is utilized so that the renewable attributes of the second volume may be attributed to the first volume, the manufacturing facility 108 can be said to manufacture organic chemicals from renewable carbon sources. In some instances, the methane or natural gas withdrawn from the distribution system 104 by the facility 108 may exceed on a mass or an energy content basis the methane or natural gas provided to the distribution system 104 by renewable sources among the sources 102. In such cases, only a portion of the methane or natural gas feedstocks shall have attached renewable environmental attributes. Depending on the methodology used, this may translate proportionally to a reduction in the renewable attributes of all the finished products produced by 108, or the renewable attributes may be disproportionately distributed among the finished products produced by 108. For example, where the second volume consists of methane and first volume has a mass or energy content that exceeds the mass or energy content of the second volume by 25%, under certain methodologies, products made by the manufacturing facility 108 can be said to have been made from 80% renewable methane and 20% fossil methane, and 80% of the finished products produced by 108 may be considered to be sourced from renewable sources and have environmental attributes derived from those renewable sources. In such cases, the renewable attributes of the methane or natural gas sources 102 and/or the second volume of methane or natural gas are attributed to the first volume withdrawn from the distribution system 104 and provided to the CO₂-steam reforming facility 110 of the manufacturing facility 108, so that when calculating the LCA-GHG equivalent emissions of the products of the manufacturing facility, the carbon intensity used for the first volume comprises the carbon intensity of the renewable methane or natural gas sources 102 and/or the second volume of methane or natural gas.

Optional pre-reformer 105 may be included to convert any C2+ hydrocarbons in the volume removed from the distribution system 104 into methane and/or syngas prior to delivery to manufacturing facility 108. For example, where the distribution system 104 is a natural gas pipeline network and the first volume withdrawn from the distribution system 104 is natural gas, and where the CO₂-steam reforming facility 110 of manufacturing facility 108 is not configured to directly convert C2+ hydrocarbons, optional pre-reformer 105 may be used to convert the C2+ hydrocarbons in the first volume into methane and/or syngas prior to injection of the stream into facility 110.

The manufacturing facility 108 can also be configured, optionally, to receive methane directly from a renewable methane source 106. In such cases, methane from the renewable methane source 106 can be routed to the manufacturing facility 108 through a conduit used also to provide methane or natural gas from the distribution system 104, or through a separate conduit. Methane sourced from the renewable methane source 106 may be more economically sourced than renewable methane obtained via the distribution system 104, since methane sourced from the renewable methane source 106 will not have the economic burden of the distribution system 104 and may avoid the need for removing the CO₂, further purification, and/or pre-reforming that might be required for methane that is transported via and then sourced from the distribution system 104. The total amount of methane available from the renewable methane source 106, however, may be insufficient to operate the manufacturing facility 108. In such cases, additional renewable methane or renewable natural gas can be obtained from the renewable sources of the methane or natural gas sources 102 and transported, using the distribution system 104, to the manufacturing facility 108 to provide sufficient operating feed gas. Methane or natural gas that is not renewable can also be sourced from the non-renewable sources of the methane or natural gas sources 102 and supplied to the manufacturing facility 108 using the distribution system 104. In such cases, the feed to the manufacturing facility 108 will contain some renewable and some non-renewable methane and thus the resulting syngas will also be a mixture of renewable and non-renewable syngas.

The renewable methane source 106 may also supply renewable CO₂ to the manufacturing facility 108. For example, the renewable methane source 106 may be a biogas facility and may supply methane and CO₂ directly from that biogas facility to the manufacturing facility 108. The volume of methane or methane-containing stream, which may be renewable methane or renewable natural gas, supplied to the manufacturing facility 108 from the methane or natural gas sources 102 using the distribution system 104 may be chosen to provide a target yield of syngas per mole of methane input while also minimizing the amount of excess CO₂ in the input, for example, where the CO₂-steam reforming unit 110 is used to produce syngas having a molar ratio of H₂:CO of about 2. Such syngas may be suitable when the facility 112 is an FT facility producing liquid hydrocarbons or a methanol facility producing methanol. To produce such syngas, when the carbon containing components in the fresh feed and/or total feed input stream to 110 are substantially only methane and CO₂, a molar ratio of CH₄:CO₂ that is between about 2.5 and 6, for example about 3 to 5, can be useful. Similar formulas can be calculated for input streams to facility 110 having more carbon containing components than just methane and CO₂ (e.g. C2+ hydrocarbons in the case such components are present and facility 110 is configured to directly process such components.)

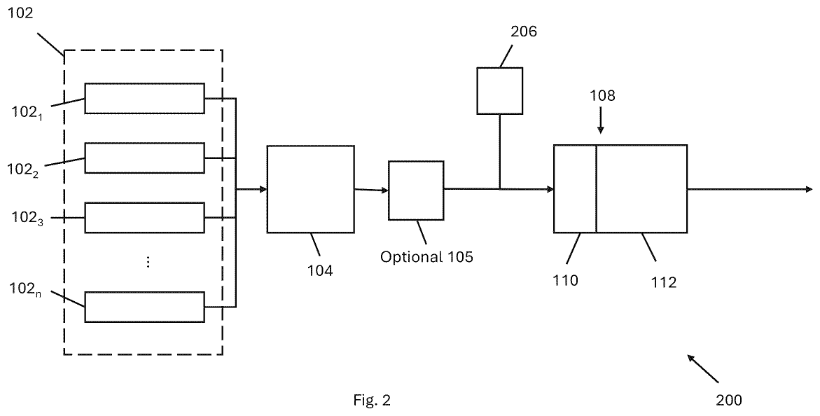

In another case, a facility for manufacturing chemical products from feedstocks produced by a CO₂-steam reforming facility can receive CO₂ from a CO₂ source while receiving methane or natural gas from a distribution system having a plurality of renewable methane or natural gas sources coupled thereto to provide renewable methane or natural gas to the distribution system. FIG. 2 is a process diagram illustrating a process 200 according to another embodiment. The process 200 also has the manufacturing facility 108, which receives a stream comprising methane or natural gas from the distribution facility 104, which in turn is supplied by the methane or natural gas sources 102, any number of which can be renewable sources. Instead of a renewable methane source 106, a CO₂ source 206 is coupled to the manufacturing facility 108 to provide CO₂. Renewable methane can be supplied to the manufacturing facility 108 from the distribution system 104, as described herein, which can be entirely renewable methane where the methane supplied to the distribution system 104 is renewable methane. As above, the renewable content of the first volume provided to the manufacturing system 108 depends on the renewable content of the second volume provided to the distribution system 104 from the sources 102, in the case that the renewable attributes of the second volume are attributed to the first volume withdrawn from the distribution system 104 under suitable balancing rules.

CO₂ from the CO₂ source 206 may be biogenic in origin, for example, it may be directly removed from the atmosphere via so-called direct air capture or captured and purified from the flue gas of a facility processing biomass, such as a pulp mill, wood processing mill, biomass combustion facility (e.g. a biomass boiler), biomass gasification facility, or other biomass to energy facility. Alternatively, the CO₂ from source 206 may be fossil in origin, for example, it may be captured from the exhaust, or be a waste gas, from an oil refinery, petrochemical plant, coal/natural gas power plant, or cement plant. CO₂ from the CO₂ source 206 can be controlled to provide a target amount of CO₂ to react, in the manufacturing system 108, to produce chemical products. The distribution system 104 can accept methane or natural gas, renewable or otherwise, having CO₂ up to a specified amount. CO₂ can be obtained from the CO₂ source to yield a feed to the manufacturing facility 108 having a target amount of methane or natural gas and CO₂ for conversion into syngas to yield syngas having a molar ratio of H₂:CO that is about 2, and then into organic chemical products. Such feed can be optimized to minimize the amount of excess H₂ produced, and the amount of CO₂ that needs to be removed, from the downstream streams. As noted above, to produce such syngas, when the carbon containing components in the input stream to facility 110 are substantially only methane and CO₂, a molar ratio of CH₄:CO₂ that is between about 2.5 and about 6, for example about 3 to about 5, can be useful. Similar formulas can be calculated for input streams to facility 110 having more carbon containing components than just methane and CO₂ (e.g. C2+ hydrocarbons in the case such components are present and facility 110 is configured to directly process such components.)

An example result using a model of a CO₂-steam reforming facility follows. The model plant uses renewable natural gas, which can be obtained from renewable sources such as landfills and livestock waste processing, and/or using a natural gas pipeline according to methods described herein, along with renewably sourced CO₂ to perform a syngas manufacturing process using a catalyst capable of catalyzing the CO₂-steam reforming reaction system. The model plant converts the syngas into liquid hydrocarbon products, with upgrading and separation into naphtha, aviation fuel, and diesel fuel products. The naphtha may be used as a gasoline blend stock, or alternatively may be used as a feedstock for manufacturing other chemicals. Appropriate optimal recycling of CO₂ and hydrocarbon, along with appropriate and optimal thermodynamic transformations to facilitate processing, are assumed for this model.

Using an energy-optimized model plant that takes in a fresh feed of 277.3 metric tonnes per day of CO₂ and 162.9 metric tonnes per day of pipeline natural gas (where such natural gas has a composition typical of North American pipeline natural gas), consumes 94.2 MW of electricity, and internally generates 14.8 MW of electricity via conversion of excess steam (which yields a net electricity import of 79.4 MW), the resulting model plant produces products at the rates of 33.4 metric tonnes per day of naphtha, 210.8 million tons per day of aviation fuel, and 34.0 million tons per day of diesel fuel. This modeling was performed using the Aspen process modeling platform. The feeds, net electricity input, and products can be equivalently described in terms of energy flow rates as follows: CO₂ feed=0 megajoules (MJ) per hour, natural gas feed=564K MJ per hour, net electricity import, 285K MJ per hour, naphtha product=66K MJ per hour, jet fuel product=393K MJ per hour, and diesel product=62K MJ per hour. In this model plant, a certain amount of off gases are produced which are not internally recycled, and these off gases have been treated as wastes rather than product. The difference between the energy in the inputs (i.e. in the feeds and net electricity import) and in the outputs (i.e. in the products) is due the exclusion of these waste off gases in the above numbers. In the above mass flows, it is also noted that water input/output is not included, and the difference in mass between the inputs and outputs is due to the exclusion of the waste off gases and water in the above numbers.

Three cases are presented below having three different mixtures of input hydrocarbons and CO₂ to make products at the rates above. Case 1 uses renewable natural gas obtained from a natural gas pipeline, as described herein, along with renewably sourced CO₂. Case 2 uses 15% hydrocarbon obtained from an on-site biogas supply along with 85% from a natural gas pipeline. The biogas supply is modeled as having a molar ratio of CO₂ to CH₄ that is 1:1, so renewably sourced CO₂ is used to supplement and supply the needed amount of CO₂. Case 3 uses biogas to supply 100% of needed CO₂ and pipeline natural gas to supplement the needed amount of hydrocarbon.

Carbon intensity of the various feed materials for the model plant are as follows. CO₂ is assumed to be renewably sourced, as described herein, and having negligible carbon intensity associated with collection and purification, so the carbon intensity is zero. Such CO₂ may be sourced from a concentrated and purified source such as bio-ethanol plant, in which case minimal processing is needed to ready the stream for use. Alternatively, such CO₂ may be sourced from unconcentrated and/or unpurified sources such as direct air capture or capture from pulp mill exhaust, where all of the energy needs to ready the stream for use are sourced from green electricity. Biogas sources are modeled as biogas from landfill and/or dairy manure processing. For Case 1, the renewable natural gas (RNG) obtained by pipeline is assumed to be a 95:5 mixture of RNG derived from landfill gas and RNG derived from dairy manure processing, giving a blended model carbon intensity of 18 gCO2e per MJ of LHV energy in the liquid hydrocarbon product. For Case 2, the RNG obtained by pipeline is assumed to be a 90:10 mixture of RNG derived from landfill gas and RNG from dairy manure processing, giving a model carbon intensity of 7.7 gCO2e per MJ of LHV energy in the liquid hydrocarbon product. For Case 3, the RNG obtained by pipeline is assumed to be an 85:15 mixture of RNG derived from landfill gas and RNG from dairy manure processing, giving a model carbon intensity of 0 gCO2e per MJ of LHV energy in the liquid hydrocarbon product. These calculated carbon intensities are based upon representative carbon intensities of 27 gCO2e per MJ of LHV energy in the RNG derived from landfill gas and −153 gCO2e per MJ of LHV energy in the RNG derived from dairy manure processing. RNG derived from landfill gas can have a wide range carbon intensities, but is frequently between 15 and 50 gCO2e per MJ of LHV energy in the RNG depending on the landfill gas facility, the distribution network, and GHG-LCA methodology. RNG derived from dairy manure processing can have a wide range carbon intensities, but is frequently between −350 and −100 gCO2e per MJ of LHV energy in the RNG depending on the dairy manure processing facility, the distribution network, and GHG-LCA methodology, provided a GHG-LCA methodology that allows inclusion of avoided emissions is used.

The three cases result in carbon intensity for the liquid hydrocarbon products of 19 gCO2e per MJ of LHV energy in the liquid hydrocarbon product for Case 1, 8 gCO2e per MJ of LHV energy in the liquid hydrocarbon product for Case 2, and 0 gCO2e per MJ of LHV energy in the liquid hydrocarbon product for Case 3. Thus, using the methods herein, and using appropriate manufacturing techniques and feedstocks, hydrocarbon products can be made, using methane from a distribution system such as a natural gas pipeline, that have very low, or zero, GHG-LCA carbon intensity. For example, hydrocarbon products can be made that have GHG-LCA carbon intensity, using any of the calculation systems described herein, of less than about 50 gCO2e per MJ of LHV energy in the liquid hydrocarbon product, such as less than 25 gCO2e per MJ of LHV energy in the liquid hydrocarbon product, for example less than 10, or even zero, gCO2e per MJ of LHV energy in the liquid hydrocarbon product. Notably this can be achieved: (a) in Case 1 with more than about 90%, more than about 95%, or more than about 98% of the hydrocarbons in the fresh feed to 108 coming from chemically fossil origin; (b) in Case 2 with more than about 50%, more than about 80%, or more than about 83% of the hydrocarbons in the fresh feed to 108 coming from chemically fossil origin; and (c) in Case 3, with more than about 50%, more than about 60%, or more than about 70% of the hydrocarbons in the fresh feed to 108 coming from chemically fossil origin.

While the foregoing is directed to embodiments of one or more inventions, other embodiments of such inventions not specifically described in the present disclosure may be devised without departing from the basic scope thereof, which is determined by the claims that follow.

1. A method, comprising:
obtaining methane from a distribution system;
obtaining a biogenic CO₂ material; and
converting the methane and the biogenic CO₂ material into a liquid hydrocarbon product,
wherein the methane is selected to provide a greenhouse gas life cycle assessment (GHG-LCA) of equivalent CO₂ emissions for the liquid hydrocarbon product, based on combustion of the liquid hydrocarbon product as a fuel as the end use, that is 50% or less of the GHG-LCA of equivalent CO₂ emissions for an equivalent fossil-derived fuel.

2. The method of claim 1, wherein the liquid hydrocarbon product is an aviation fuel and the fossil-derived fuel is an aviation fuel.

3. The method of claim 1, wherein the liquid hydrocarbon product is a diesel fuel and the fossil-derived fuel is a diesel fuel.

4. The method of claim 1, wherein the liquid hydrocarbon product is a gasoline blendstock and the fossil-derived fuel is gasoline.

5. The method of claim 1, wherein the liquid hydrocarbon product has a GHG-LCA of no more than about 30 grams of equivalent CO₂ emissions per Megajoule of lower heating value (LHV) energy in the liquid hydrocarbon product.

6. The method of claim 5, wherein the fossil-derived transportation fuel has a GHG-LCA of no less than about 75 grams of equivalent CO₂ emissions per Megajoule of lower heating value (LHV) energy in the liquid hydrocarbon product.

7. The method of claim 1, wherein the methane is part of a natural gas material obtained from a pipeline.

8. The method of claim 1, further comprising supplying renewable methane to the distribution system in a quantity selected to provide the GHG-LCA of equivalent CO₂ emissions for the liquid hydrocarbon product, based on combustion as a fuel as the end use, that is 50% or less of the GHG-LCA equivalent CO₂ emissions for an equivalent fossil-derived fuel.

9. The method of claim 1, wherein converting the methane and the biogenic CO₂ material into a liquid hydrocarbon product comprises exposing the methane and the biogenic CO₂ material to a single heterogeneous catalyst capable of catalyzing a steam methane reforming reaction, a dry reforming reaction, and a water-gas shifting reaction.

10. A method, comprising:
supplying, to a hydrocarbon manufacturing facility, through a distribution system, methane that, when reacted with biogenic CO₂ forms a liquid hydrocarbon product that has a greenhouse gas life cycle assessment (GHG-LCA) of equivalent CO₂ emissions, based on combustion of the liquid hydrocarbon product as a fuel as the end use, that is 50% or less of the GHG-LCA of an equivalent fossil-derived fuel.

11. The method of claim 10, wherein the liquid hydrocarbon product is an aviation fuel, a diesel fuel, or a gasoline blendstock and the fossil-derived fuel is a corresponding aviation fuel, diesel fuel, or gasoline blendstock.

12. The method of claim 10, wherein the distribution system is a pipeline, and the methane is supplied to the hydrocarbon manufacturing facility by putting one or more renewably sourced natural gas materials into the pipeline at one or more locations.

13. The method of claim 10, wherein the supplied methane is a first volume of methane, and the supplied methane utilizes equivalent CO₂ emissions calculated based on the GHG-LCA of a second volume of renewably sourced methane input into the distribution system.

14. The method of claim 10, further comprising withdrawing a volume of methane from the distribution system and converting the methane, and a volume of biogenic CO₂ into the liquid hydrocarbon product by exposing the withdrawn methane and the volume of biogenic CO₂ to a single heterogeneous catalyst that catalyzes CO₂-steam reforming.

15. The method of claim 10, wherein the methane is a first volume of methane, and further comprising supplying a second volume of methane to the manufacturing facility that is derived from a fossil source.

16. The method of claim 10, wherein the liquid hydrocarbon product is naphtha, diesel fuel, aviation fuel, or any combination thereof.

17. A method, comprising:
obtaining, from a distribution system at a first location, a first volume of methane having a mass or energy content that is the same as, or less than, a mass or energy content of a corresponding second volume of renewably sourced methane input into the distribution system at a second location different from the first location;
obtaining a volume of renewably sourced CO₂; and
converting the first volume of methane and the volume of renewably sourced CO₂ into a liquid hydrocarbon product,
wherein the second volume is selected to provide a greenhouse gas life cycle assessment (GHG-LCA) of equivalent CO₂ emissions for the liquid hydrocarbon product, based on combustion of the liquid hydrocarbon product as a fuel as the end use, that is 50% or less of the GHG-LCA of an equivalent fossil-derived fuel.

18. The method of claim 17, wherein converting the first volume of methane and the volume of renewably sourced CO₂ into the liquid hydrocarbon product comprises exposing the first volume of methane and the volume of renewably sourced CO₂ to a single catalyst comprising a noble metal supported on a supporting comprising a metal oxide, wherein the single catalyst catalyzes CO₂-steam reforming.

19. A method, comprising:
obtaining, from a distribution system at a first location, a first volume of methane having a first mass or energy content;
causing to be supplied to the distribution system, at a second location different from the first location, a second volume of renewably sourced methane having a second mass or energy content equal to or greater than the first mass;
combining the first volume with a volume of renewably sourced CO₂ from a biogas facility to form a feed stream; and
converting the first volume of methane and the volume of renewably sourced CO₂ of the feed stream into a liquid hydrocarbon product,
wherein the second volume is selected to provide a greenhouse gas life cycle assessment (GHG-LCA) of equivalent CO₂ emissions for the liquid hydrocarbon product, based on combustion of the liquid hydrocarbon product as a fuel as the end use, that is 50% or less of the GHG-LCA of equivalent CO₂ emissions for an equivalent fossil-derived fuel.

20. The method of claim 19, wherein the GHG-LCA of the liquid hydrocarbon product is no more than about 30 grams of equivalent CO₂ emissions per Megajoule of lower heating value (LHV) energy in the liquid hydrocarbon product, and wherein converting the first volume of methane and the volume of renewably sourced CO₂ into a liquid hydrocarbon product comprises exposing the first volume of methane and the volume of renewably sourced CO₂ to a single heterogeneous catalyst that catalyzes CO₂-steam reforming.
